(19) United States
(12) Patent Application Publication
(10) Pub. No.: US 2021/0261417 A1
(43) Pub. Date: Aug. 26, 2021

(54) SYSTEMS AND METHODS FOR PROCESSING

(71) Applicant: Monolith Materials, Inc., Lincoln, NE (US)

(72) Inventors: Christopher J.-P. Cardinal, Sunnyvale, CA (US); Peter L. Johnson, Mountain View, CA (US)

(21) Appl. No.: 17/062,075

(22) Filed: Oct. 2, 2020

Related U.S. Application Data
(63) Continuation of application No. PCT/US2019/025632, filed on Apr. 3, 2019.
(60) Provisional application No. 62/652,106, filed on Apr. 3, 2018.

(51) Int. Cl. C01B 32/05; C01B 3/02; C10G 47/22

(52) U.S. Cl. CPC C01B 32/05; C01B 3/02; C01B 2203/0861; C01B 2203/061; C01B 2203/068; C10G 47/22

(57) ABSTRACT

Particles may be generated using systems and methods provided herein. The particles may include carbon particles.

### CROSS-REFERENCE

This application is a continuation of International Application No. PCT/US2019/25632, filed Apr. 3, 2019, which claims the benefit of U.S. Provisional Application No. 62/652,106, filed Apr. 3, 2018, each of which is entirely incorporated herein by reference.

### BACKGROUND

Particles are used in many household and industrial applications. The particles may be produced by various chemical processes. Performance and energy supply associated with such chemical processes has evolved over time.

### SUMMARY

The present disclosure recognizes a need for more efficient and effective processes to produce particles, such as, for example, carbon particles. Also recognized herein is a need to increase speed of production, increase yields, reduce manufacturing equipment wear characteristics, etc. The present disclosure may provide, for example, improved processes for converting hydrocarbon-containing materials into carbon particles.

The present disclosure provides, for example, a method for generating carbon particles, comprising: providing a first material stream; converting at least a portion of the first material stream to a second material stream; heating a third material stream; and generating the carbon particles in a reactor comprising the third material stream and at least one of the first material stream and the second material stream. The method may further comprise generating the carbon particles substantially free of atmospheric oxygen. The method may further comprise mixing the third material stream with at least one of the first material stream and the second material stream to generate the carbon particles and hydrogen gas. The carbon particles may include carbon black. The method may further comprise electrically heating the third material stream. The method may further comprise electrically heating the third material stream with the aid of a plasma generator. The method may further comprise catalytically converting at least a portion of the first material stream to the second material stream. The method may further comprise converting at least about 1%, 10% or 30% of the first material stream to the second material stream. The third material stream may comprise greater than about 60% hydrogen. The first material stream may comprise one or more hydrocarbons. The first material stream may comprise at least about 70% by weight methane, ethane, propane or mixtures thereof. The first material stream may comprise methane. The first material stream may comprise natural gas. The second material stream may comprise methane, natural gas, ethane, propane, butane, pentane, benzene, toluene, xylene, ethylbenzene, naphthalene, methyl naphthalene, dimethyl naphthalene, anthracene, methyl anthracene, carbon black oil, pyrolysis fuel oil, coal tar, crude coal tar, heavy oil, ethylene, acetylene, propylene, butadiene, styrene, ethanol, methanol, propanol, phenol, one or more ketones, one or more ethers, one or more esters, one or more aldehydes, or any combination thereof. The method may further comprise sharing waste heat between the steps of generating the carbon particles and converting at least a portion of the first material stream to the second material stream. The method may further comprise using waste heat from generating the carbon particles to provide at least a portion of required thermal energy for converting at least a portion of the first material stream to the second material stream.

These and additional embodiments are further described below.

### BRIEF DESCRIPTION OF DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “FIG.” and “FIGs.” herein), of which:

FIG. 1 shows a schematic representation of an example of a process; and

FIG. 2 shows a schematic representation of an example of a system.

### DETAILED DESCRIPTION

The particulars shown herein are by way of example and for purposes of illustrative discussion of the various embodiments of the present invention only and are presented in the cause of providing what is believed to be the most useful and readily understood description of the principles and conceptual aspects of the invention. In this regard, no attempt is made to show details of the invention in more detail than is necessary for a fundamental understanding of the invention, the description making apparent to those skilled in the art how the several forms of the invention may be embodied in practice.

The present invention will now be described by reference to more detailed embodiments. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise. All publications, patent applications, patents, and other references mentioned herein are expressly incorporated by reference in their entirety.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Every numerical range given throughout this specification will include every narrower numerical range that falls within such broader numerical range, as if such narrower numerical ranges were all expressly written herein.

Additional advantages of the invention will be set forth in part in the description which follows, and in part will be obvious from the description, or may be learned by practice of the invention. It is to be understood that both the foregoing general description and the following detailed description are exemplary and explanatory only and are not restrictive of the invention, as claimed. It shall be understood that different aspects of the invention can be appreciated individually, collectively, or in combination with each other.

The present disclosure provides systems and methods for affecting chemical changes. Affecting such chemical changes may include making particles (e.g., carbon particles, such as, for example, carbon black) using the systems and methods of the present disclosure. The systems (e.g., apparatuses) and methods of the present disclosure, and processes implemented with the aid of the systems and methods herein, may allow continuous production of, for example, carbon black or carbon-containing compounds. The systems and methods described herein may enable continuous operation and production of high quality carbon particles (e.g., carbon black). The processes may include converting a carbon-containing feedstock. The systems and methods described herein may include heating hydrocarbons rapidly to form carbon particles (e.g., carbon black). For example, the hydrocarbons may be heated rapidly to form carbon particles (e.g., carbon black) and hydrogen. Hydrogen may in some cases refer to majority hydrogen. For example, some portion of this hydrogen may also contain methane (e.g., unspent methane) and/or various other hydrocarbons (e.g., ethane, propane, ethylene, acetylene, benzene, toluene, polycyclic aromatic hydrocarbons (PAH) such as naphthalene, etc.).

The process may include heating a thermal transfer gas (e.g., a plasma gas) with electrical energy (e.g., from a DC or AC source). The thermal transfer gas may be heated by an electric arc. The thermal transfer gas may be heated by Joule heating (e.g., resistive heating, induction heating, or a combination thereof). The thermal transfer gas may be heated by Joule heating and by an electric arc (e.g., downstream of the Joule heating). The thermal transfer gas may be heated by heat exchange, by Joule heating, by an electric arc, or any combination thereof. The thermal transfer gas may be heated by heat exchange, by Joule heating, by combustion, or any combination thereof. The process may further include mixing injected feedstock with the heated thermal transfer gas (e.g., plasma gas) to achieve suitable reaction conditions. The hydrocarbon may be mixed with the hot gas to affect removal of hydrogen from the hydrocarbon. The products of reaction may be cooled, and the carbon particles (e.g., carbon black) or carbon-containing compounds may be separated from the other reaction products. The as-produced hydrogen may be recycled back into the reactor.

The thermal transfer gas may in some instances be heated in an oxygen-free environment. The carbon particles may in some instances be produced (e.g., manufactured) in an oxygen-free atmosphere. An oxygen-free atmosphere may comprise, for example, less than about 5% oxygen by volume, less than about 3% oxygen (e.g., by volume), or less than about 1% oxygen (e.g., by volume).

The thermal transfer gas may comprise at least about 60% hydrogen up to about 100% hydrogen (by volume) and may further comprise up to about 30% nitrogen, up to about 30% CO, up to about 30% CH₄, up to about 10% HCN, up to about 30% C₂H₂, and up to about 30% Ar. For example, the thermal transfer gas may be greater than about 60% hydrogen. Additionally, the thermal transfer gas may also comprise polycyclic aromatic hydrocarbons such as anthracene, naphthalene, coronene, pyrene, chrysene, fluorene, and the like. In addition, the thermal transfer gas may have benzene and toluene or similar monoaromatic hydrocarbon components present. For example, the thermal transfer gas may comprise greater than or equal to about 90% hydrogen, and about 0.2% nitrogen, about 1.0% CO, about 1.1% CH₄, about 0.1% HCN and about 0.1% C₂H₂. The thermal transfer gas may comprise greater than or equal to about 80% hydrogen and the remainder may comprise some mixture of the aforementioned gases, polycyclic aromatic hydrocarbons, monoaromatic hydrocarbons and other components. Thermal transfer gas such as oxygen, nitrogen, argon, helium, air, hydrogen, carbon monoxide, hydrocarbon (e.g., methane, ethane, unsaturated) etc. (used alone or in mixtures of two or more) may be used. The thermal transfer gas may comprise greater than or equal to about 50% hydrogen by volume. The thermal transfer gas may comprise, for example, oxygen, nitrogen, argon, helium, air, hydrogen, hydrocarbon (e.g. methane, ethane) etc. (used alone or in mixtures of two or more). The thermal transfer gas may comprise greater than about 70% H₂ by volume and may include at least one or more of the gases HCN, CH₄, C₂H₄, C₂H₂, CO, benzene or polyaromatic hydrocarbon (e.g., naphthalene and/or anthracene) at a level of at least about 1 ppm. The polyaromatic hydrocarbon may comprise, for example, naphthalene, anthracene and/or their derivatives. The polyaromatic hydrocarbon may comprise, for example, methyl naphthalene and/or methyl anthracene. The thermal transfer gas may comprise a given thermal transfer gas (e.g., among the aforementioned thermal transfer gases) at a concentration (e.g., in a mixture of thermal transfer gases) greater than or equal to about 1 ppm, 5 ppm, 10 ppm, 25 ppm, 50 ppm, 0.01%, 0.05%, 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.5%, 3%, 3.5%, 4%, 4.5%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 2′7%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 55%, 60%, 65%, 70%, 75%, 80%, 85%, 90%, 95% or 99% by weight, volume or mole. Alternatively, or in addition, the thermal transfer gas may comprise the given thermal transfer gas at a concentration (e.g., in a mixture of thermal transfer gases) less than or equal to about 100%, 99%, 95%, 90%, 85%, 80%, 75%, 70%, 65%, 60%, 55%, 50%, 49%, 48%, 47%, 46%, 45%, 44%, 43%, 42%, 41%, 40%, 39%, 38%, 37%, 36%, 35%, 34%, 33%, 32%, 31%, 30%, 29%, 28%, 27%, 26%, 25%, 24%, 23%, 22%, 21%, 20%, 19%, 18%, 17%, 16%, 15%, 14%, 13%, 12%, 11%, 10%, 9%, 8%, 7%, 6%, 5%, 4.5%, 4%, 3.5%, 3%, 2.5%, 2%, 1.9%, 1.8%, 1.7%, 1.6%, 1.5%, 1.4%, 1.3%, 1.2%, 1.1%, 1%, 0.9%, 0.8%, 0.7%, 0.6%, 0.5%, 0.4%, 0.3%, 0.2%, 0.1%, 0.05%, 0.01%, 50 ppm, 25 ppm, 10 ppm, 5 ppm or 1 ppm by weight, volume or mole. The thermal transfer gas may comprise additional thermal transfer gases (e.g., in a mixture of thermal transfer gases) at similar or different concentrations. Such additional thermal transfer gases may be selected, for example, among the aforementioned thermal transfer gases not selected as the given thermal transfer gas. The given thermal transfer gas may itself comprise a mixture. The thermal transfer gas may have at least a subset of such compositions before, during and/or after heating.

The hydrocarbon feedstock may include any chemical with formula CₙHₓ or CₙHₓO_{y}, where n is an integer; x is between (i) 1 and 2n+2 or (ii) less than 1 for fuels such as coal, coal tar, pyrolysis fuel oils, and the like; and y is between 0 and n. The hydrocarbon feedstock may include, for example, simple hydrocarbons (e.g., methane, ethane, propane, butane, etc.), aromatic feedstocks (e.g., benzene, toluene, xylene, methyl naphthalene, pyrolysis fuel oil, coal tar, coal, heavy oil, oil, bio-oil, bio-diesel, other biologically derived hydrocarbons, and the like), unsaturated hydrocarbons (e.g., ethylene, acetylene, butadiene, styrene, and the like), oxygenated hydrocarbons (e.g., ethanol, methanol, propanol, phenol, ketones, ethers, esters, and the like), or any combination thereof. These examples are provided as non-limiting examples of acceptable hydrocarbon feedstocks which may further be combined and/or mixed with other components for manufacture. A hydrocarbon feedstock may refer to a feedstock in which the majority of the feedstock (e.g., more than about 50% by weight) is hydrocarbon in nature. The reactive hydrocarbon feedstock may comprise at least about 70% by weight methane, ethane, propane or mixtures thereof. The hydrocarbon feedstock may comprise or be natural gas. The hydrocarbon may comprise or be methane, ethane, propane or mixtures thereof. The hydrocarbon may comprise methane, ethane, propane, butane, acetylene, ethylene, carbon black oil, coal tar, crude coal tar, diesel oil, benzene and/or methyl naphthalene. The hydrocarbon may comprise (e.g., additional) polycyclic aromatic hydrocarbons. The hydrocarbon feedstock may comprise one or more simple hydrocarbons, one or more aromatic feedstocks, one or more unsaturated hydrocarbons, one or more oxygenated hydrocarbons, or any combination thereof. The hydrocarbon feedstock may comprise, for example, methane, ethane, propane, butane, pentane, natural gas, benzene, toluene, xylene, ethylbenzene, naphthalene, methyl naphthalene, dimethyl naphthalene, anthracene, methyl anthracene, other monocyclic or polycyclic aromatic hydrocarbons, carbon black oil, diesel oil, pyrolysis fuel oil, coal tar, crude coal tar, coal, heavy oil, oil, bio-oil, bio-diesel, other biologically derived hydrocarbons, ethylene, acetylene, propylene, butadiene, styrene, ethanol, methanol, propanol, phenol, one or more ketones, one or more ethers, one or more esters, one or more aldehydes, or any combination thereof. The feedstock may comprise one or more derivatives of feedstock compounds described herein, such as, for example, benzene and/or its derivative(s), naphthalene and/or its derivative(s), anthracene and/or its derivative(s), etc. The hydrocarbon feedstock (also “feedstock” herein) may have a composition as described elsewhere herein.

The thermal transfer gas may be provided to the system (e.g., to a reactor, such as, for example, reactor 102 or 212 described herein) at a rate of, for example, greater than or equal to about 1 normal cubic meter/hour (Nm³/hr), 2 Nm³/hr, 5 Nm³/hr, 10 Nm³/hr, 25 Nm³/hr, 50 Nm³/hr, 75 Nm³/hr, 100 Nm³/hr, 150 Nm³/hr, 200 Nm³/hr, 250 Nm³/hr, 300 Nm³/hr, 350 Nm³/hr, 400 Nm³/hr, 450 Nm³/hr, 500 Nm³/hr, 550 Nm³/hr, 600 Nm³/hr, 650 Nm³/hr, 700 Nm³/hr, 750 Nm³/hr, 800 Nm³/hr, 850 Nm³/hr, 900 Nm³/hr, 950 Nm³/hr, 1,000 Nm³/hr, 2,000 Nm³/hr, 3,000 Nm³/hr, 4,000 Nm³/hr, 5,000 Nm³/hr, 6,000 Nm³/hr, 7,000 Nm³/hr, 8,000 Nm³/hr, 9,000 Nm³/hr, 10,000 Nm³/hr, 12,000 Nm³/hr, 14,000 Nm³/hr, 16,000 Nm³/hr, 18,000 Nm³/hr, 20,000 Nm³/hr, 30,000 Nm³/hr, 40,000 Nm³/hr, 50,000 Nm³/hr, 60,000 Nm³/hr, 70,000 Nm³/hr, 80,000 Nm³/hr, 90,000 Nm³/hr or 100,000 Nm³/hr. Alternatively, or in addition, the thermal transfer gas may be provided to the system (e.g., to the reactor) at a rate of, for example, less than or equal to about 100,000 Nm³/hr, 90,000 Nm³/hr, 80,000 Nm³/hr, 70,000 Nm³/hr, 60,000 Nm³/hr, 50,000 Nm³/hr, 40,000 Nm³/hr, 30,000 Nm³/hr, 20,000 Nm³/hr, 18,000 Nm³/hr, 16,000 Nm³/hr, 14,000 Nm³/hr, 12,000 Nm³/hr, 10,000 Nm³/hr, 9,000 Nm³/hr, 8,000 Nm³/hr, 7,000 Nm³/hr, 6,000 Nm³/hr, 5,000 Nm³/hr, 4,000 Nm³/hr, 3,000 Nm³/hr, 2,000 Nm³/hr, 1,000 Nm³/hr, 950 Nm³/hr, 900 Nm³/hr, 850 Nm³/hr, 800 Nm³/hr, 750 Nm³/hr, 700 Nm³/hr, 650 Nm³/hr, 600 Nm³/hr, 550 Nm³/hr, 500 Nm³/hr, 450 Nm³/hr, 400 Nm³/hr, 350 Nm³/hr, 300 Nm³/hr, 250 Nm³/hr, 200 Nm³/hr, 150 Nm³/hr, 100 Nm³/hr, 75 Nm³/hr, 50 Nm³/hr, 25 Nm³/hr, 10 Nm³/hr, 5 Nm³/hr or 2 Nm³/hr. The thermal transfer gas may be provided to the system (e.g., to the reactor) at such rates in combination with one or more feedstock flow rates described herein.

The feedstock (e.g., hydrocarbon) may be provided to the system (e.g., to a reactor, such as, for example, reactor 102 or 212 described herein) at a rate of, for example, greater than or equal to about 50 grams per hour (g/hr), 100 g/hr, 250 g/hr, 500 g/hr, 750 g/hr, 1 kilogram per hour (kg/hr), 2 kg/hr, 5 kg/hr, 10 kg/hr, 15 kg/hr, 20 kg/hr, 25 kg/hr, 30 kg/hr, 35 kg/hr, 40 kg/hr, 45 kg/hr, 50 kg/hr, 55 kg/hr, 60 kg/hr, 65 kg/hr, 70 kg/hr, 75 kg/hr, 80 kg/hr, 85 kg/hr, 90 kg/hr, 95 kg/hr, 100 kg/hr, 150 kg/hr, 200 kg/hr, 250 kg/hr, 300 kg/hr, 350 kg/hr, 400 kg/hr, 450 kg/hr, 500 kg/hr, 600 kg/hr, 700 kg/hr, 800 kg/hr, 900 kg/hr, 1,000 kg/hr, 1,100 kg/hr, 1,200 kg/hr, 1,300 kg/hr, 1,400 kg/hr, 1,500 kg/hr, 1,600 kg/hr, 1,700 kg/hr, 1,800 kg/hr, 1,900 kg/hr, 2,000 kg/hr, 2,100 kg/hr, 2,200 kg/hr, 2,300 kg/hr, 2,400 kg/hr, 2,500 kg/hr, 3,000 kg/hr, 3,500 kg/hr, 4,000 kg/hr, 4,500 kg/hr, 5,000 kg/hr, 6,000 kg/hr, 7,000 kg/hr, 8,000 kg/hr, 9,000 kg/hr or 10,000 kg/hr. Alternatively, or in addition, the feedstock (e.g., hydrocarbon) may be provided to the system (e.g., to the reactor) at a rate of, for example, less than or equal to about 10,000 kg/hr, 9,000 kg/hr, 8,000 kg/hr, 7,000 kg/hr, 6,000 kg/hr, 5,000 kg/hr, 4,500 kg/hr, 4,000 kg/hr, 3,500 kg/hr, 3,000 kg/hr, 2,500 kg/hr, 2,400 kg/hr, 2,300 kg/hr, 2,200 kg/hr, 2,100 kg/hr, 2,000 kg/hr, 1,900 kg/hr, 1,800 kg/hr, 1,700 kg/hr, 1,600 kg/hr, 1,500 kg/hr, 1,400 kg/hr, 1,300 kg/hr, 1,200 kg/hr, 1,100 kg/hr, 1,000 kg/hr, 900 kg/hr, 800 kg/hr, 700 kg/hr, 600 kg/hr, 500 kg/hr, 450 kg/hr, 400 kg/hr, 350 kg/hr, 300 kg/hr, 250 kg/hr, 200 kg/hr, 150 kg/hr, 100 kg/hr, 95 kg/hr, 90 kg/hr, 85 kg/hr, 80 kg/hr, 75 kg/hr, 70 kg/hr, 65 kg/hr, 60 kg/hr, 55 kg/hr, 50 kg/hr, 45 kg/hr, 40 kg/hr, 35 kg/hr, 30 kg/hr, 25 kg/hr, 20 kg/hr, 15 kg/hr, 10 kg/hr, 5 kg/hr, 2 kg/hr, 1 kg/hr, 750 g/hr, 500 g/hr, 250 g/hr or 100 g/hr.

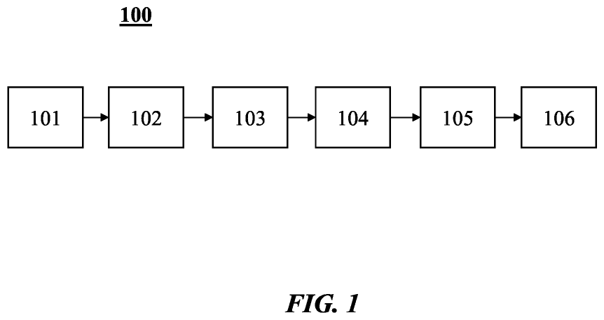

FIG. 1 shows an example of a flow chart of a process 100. The process may begin through addition of hydrocarbon to hot gas (e.g., heat+hydrocarbon) 101. The process may include one or more of the steps of heating the gas (e.g., thermal transfer gas), adding the hydrocarbon to the hot gas (e.g., 101), passing through a furnace or reactor 102, and using one or more of a heat exchanger 103 (e.g., connected to the reactor), filter (e.g., a main filter) 104 (e.g., connected to the heat exchanger), degas (e.g., degas chamber or apparatus) 105 (e.g., connected to the filter) and back end 106. As non-limiting examples of other components, a conveying process, a process filter, cyclone, classifier and/or hammer mill may be added (e.g., optionally). The back end equipment 106 may include, for example, one or more of a pelletizer (e.g., connected to the degas apparatus), a binder mixing tank (e.g., connected to the pelletizer), and a dryer (e.g., connected to the pelletizer). The back end of the reactor may comprise a pelletizer, a dryer and/or a bagger as non-limiting example(s) of components. More components or fewer components may be added or removed. The carbon particles (e.g., black) may also pass through classifiers, hammer mills and/or other size reduction equipment (e.g., so as to reduce the proportion of grit in the product).

The hot gas may be a stream of hot gas at an average temperature of over about 2,200° C. The hot gas may have a composition as described elsewhere herein (e.g., the hot gas may comprise greater than 50% hydrogen by volume). The process may include heating a gas (e.g., comprising 50% or greater by volume hydrogen) and then adding this hot gas to a hydrocarbon at 101. Heat may (e.g., also) be provided through latent radiant heat from the wall of the reactor. This may occur through heating of the walls via externally provided energy or through the heating of the walls from the hot gas. The heat may be transferred from the hot gas to the hydrocarbon feedstock. This may occur immediately upon addition of the hydrocarbon feedstock to the hot gas in the reactor or the reaction zone 102. A “reactor” may refer to an apparatus (e.g., a larger apparatus comprising a reactor section (or a reaction chamber or a reaction zone)), or to the reactor section (or a reaction chamber or a reaction zone) only. The hydrocarbon may begin to crack and decompose before being fully converted into carbon particles (e.g., carbon black). The reaction products may be cooled after manufacture. A quench may be used to cool the reaction products. For example, a quench comprising a majority of hydrogen gas may be used. The quench may be injected in the reactor portion of the process. A heat exchanger may be used to cool the process gases. In the heat exchanger, the process gases may be exposed to a large amount of surface area and thus allowed to cool, while the product stream may be simultaneously transported through the process. The effluent stream of gases and carbon particles (e.g., carbon black particles) may be (e.g., subsequently) passed through a filter which allows more than 50% of the gas to pass through, capturing substantially all of the carbon particles (e.g., carbon black particles) on the filter. At least about 98% by weight of the carbon particles (e.g., carbon black particles) may be captured on the filter. The carbon particles (e.g., carbon black) with residual gas may (e.g., subsequently) pass through a degas apparatus where the amount of combustible gas is reduced (e.g., to less than about 10% by volume). The carbon particles (e.g., carbon black particles) may be (e.g., subsequently) mixed with water with a binder and then formed into pellets, followed by removal of the majority of the water in a dryer.

At least a portion (e.g., a particle generating portion) of a system of the present disclosure may be configured to implement an enclosed process. Such an enclosed particle generating system may include, for example, an enclosed particle generating reactor. The enclosed process may include a thermal generator (e.g., a plasma generator), a reaction chamber, a main filter, and a degas chamber. These components may be substantially free of oxygen and other atmospheric gases. The process (or portions thereof) may allow only a given atmosphere.

At least a portion (e.g., a particle generating portion) of a process of the present disclosure may contain the reactants and products up until a degas step has been completed to remove the combustible gas(es) (e.g., hydrogen) produced from the cracking of the hydrocarbon feedstock (e.g., methane). Hydrogen, a highly combustible gas, may be separated from the as-produced carbon particles (e.g., carbon black) in order to manipulate the carbon particles.

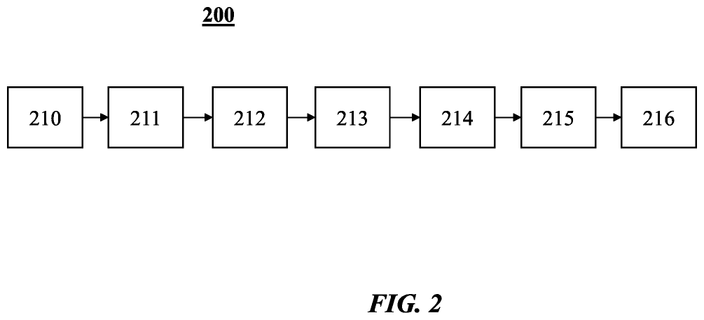

FIG. 2 shows an example of a system 200. The system may include a thermal generator (e.g., a plasma generator) 210 that generates hot gas (e.g., plasma) to which a feedstock (e.g., a feedstock gas, such as, for example, methane) 211 may be added (e.g., at a feedstock gas inlet). The mixed gases may enter into a reactor 212 where the carbon particles (e.g., carbon black) are generated followed by a heat exchanger 213. The carbon particles (e.g., carbon black) may then be filtered at filter 214, pelletized in a pelletizer 215 and dried in a dryer 216. Other unit operations may exist, for example, between the filter and pelletizer units shown, or elsewhere as desired or appropriate (e.g., as described elsewhere herein). They may include, for example, hydrogen/tail gas removal units, conveying units, process filter units, classification units, grit reduction mill units, purge filter units (e.g., which may filter black out of steam vented from dryer), dust filter units (e.g., which may collect dust from other equipment), off quality product blending units, etc.

The injected hydrocarbon may be cracked such that at least about 80% by moles of the hydrogen originally chemically attached through covalent bonds to the hydrocarbon may be homoatomically bonded as diatomic hydrogen. Homoatomically bonded may refer to the bond being between two atoms that are the same (e.g., as in diatomic hydrogen or H₂). C—H may be a heteroatomic bond. A hydrocarbon may go from heteroatomically bonded C—H to homoatomically bonded H—H and C—C. This may just refer to the H₂ from the CH₄ or other hydrocarbon feedstock (e.g., the H₂ from the plasma may still be present).

Carbon particles may be generated at a yield (e.g., yield of carbon particles based upon feedstock conversion rate, based on total hydrocarbon injected, on a weight percent carbon basis, or as measured by moles of product carbon vs. moles of reactant carbon) of, for example, greater than or equal to about 1%, 5%, 10%, 25%, 50%, 55%, 60%, 65%, 70%, 75%, 80%, 85%, 90%, 91%, 92%, 93%, 94%, 95%, 96%, 97%, 98%, 99%, 99.5% or 99.9%. Alternatively, or in addition, the carbon particles may be generated at a yield (e.g., yield of carbon particles based upon feedstock conversion rate, based on total hydrocarbon injected, on a weight percent carbon basis, or as measured by moles of product carbon vs. moles of reactant carbon) of, for example, less than or equal to about 100%, 99.9%, 99.5%, 99%, 98%, 97%, 96%, 95%, 94%, 93%, 92%, 91%, 90%, 85%, 80%, 75%, 70%, 65%, 60%, 55%, 50%, 25% or 5%.

The systems (e.g., apparatuses) and methods of the present disclosure, and processes implemented with the aid of the systems and methods herein, may, for example, provide feedstock flexibility, increase overall throughput of a given grade of carbon particles (e.g., carbon black) and/or provide other advantages (e.g., as described in greater detail elsewhere herein).

The present disclosure provides, for example, systems and methods for cracking feedstock (e.g., with plasma) in an apparatus having a series of unit operations with individual capacities. The unit operations may include at least one reactor unit, at least one heat exchanger unit, and/or at least one filter unit. The unit operations may include at least one dryer unit. The unit operations may include at least one pelletizer unit. The individual capacities of the unit operations may be substantially balanced by replacing at least part of the feedstock with a heavier feedstock (e.g., a feedstock having a molecular weight heavier than methane), which may result in increased utilization of the individual capacities of the unit operations and/or increased overall throughput. The heavier feedstock may be at least one gas. The heavier feedstock may contain a higher carbon content (e.g., a carbon content higher than methane). The heavier feedstock may comprise or be, for example, one or more of ethane, propane, butane, acetylene, ethylene, carbon black oil, coal tar, crude coal tar, diesel oil, benzene, and methyl naphthalene. The heavier feedstock may comprise one or more (e.g., additional) polycyclic aromatic hydrocarbons.

At least a portion of a given feedstock may be replaced with a heavier feedstock. While heavier may refer to relative molecular weights (e.g., grams per mole), the carbon content of the feedstock (e.g., % carbon by weight) may best represent the potential for improvement. The increasing presence of unsaturated bonds within the feedstock may (e.g., also) have a positive effect on the process, such as, for example, the use of ethylene in place of or in addition to ethane. If the hydrocarbon feedstock is represented by the chemical formula CₙH₍₂ₙ₊₂₎, the results described herein may improve with increase in “n”. However, with unsaturated and/or cyclical compounds, the +2 may actually change to a smaller or negative number (e.g., carbon black feedstock in a furnace process is typically CₙHₙ, and coal tar CₙH_{n/2}). While the gas form of the feedstock may typically be used, while it may be more expensive, liquid forms of the feedstocks described herein may (e.g., also) be employed. While relative cost may be a consideration to be factored into the selection, in addition to ethane, any additional gases or liquids (e.g., gases or liquids operable in conventional carbon black producing processes) may be selected, including, but not limited to, for example, propane, butane, acetylene, ethylene, carbon black oil, coal tar, crude coal tar, diesel oil, benzene, methyl naphthalene, etc.

Heavier feedstock (e.g., ethane or heavier feedstock gases) may be used to reduce costs and balance reactor capacity in a reactor (e.g., plasma reactor). For example, ethane and/or other heavier than methane hydrocarbons may be used in place of part or all of the methane as the process' feedstock. The use of heavier feedstock (e.g., feedstock heavier than methane) in a process as described herein (e.g., a plasma process) may reduce the required energy per unit of production. Use of heavier feedstocks may result in lower raw material costs and/or higher energy efficiencies. Replacing a portion or all of a lighter feedstock (e.g., methane/natural gas) as feedstock with a heavier feedstock may allow for better (or ideally full) utilization of the front and back end individual unit capacities and so reduce overall costs or increase profitability, even when the heavier feedstock costs more than the lighter feedstock, by spreading fixed costs over a higher amount of product produced per unit of time, or simply by generating additional product to sell. Use of heavier feedstocks may (e.g., also) improve product quality (e.g., lower grit and/or extract from forming product faster, higher structure/CDBP (crushed dibutyl phthlate number) or DBP (dibutyl phthlate number) and/or higher surface area). The use of heavier feedstock may provide various combinations of the aforementioned and/or other advantages described herein.

The use of a heavier feedstock (e.g., ethane) to substitute a portion of a lighter feedstock (e.g., methane) in a way that increases, for example, reactor, heat exchanger and/or filter capacity so that it matches the available downstream capacity of, for example, heat exchanger/product cooler, filter, pelletizer and/or dryer capacity (often the dryer being the limit to production) may be extremely advantageous. For example, this balancing of capacity may result in higher profitability from increased sales on reactor, heat exchanger or filter limited grades even when the raw material cost, or even the total cost, of the product increases due to the potentially higher cost of ethane or heavier feedstocks. The use of the heavier feedstock may enrich the feedstock used and so increase the utilization of the utilization of the back end (e.g., of the back end of the plasma unit), which may result in enabling higher sales and profitability, and/or satisfy customer demands for additional more expensive-to-make product.

The use of the heavier feedstocks as described herein may result in the ability to balance or match the capacities of each unit of operation. Production from the full set of equipment may be restricted to the lowest individual unit capacity step, with those capacity limits often determined by such things as the grade of production and the feedstock used. Often reactor limits may match filter limits, but heat exchanger limits may represent a different limit for the process. For example, furnace processes typically couple the reactor and heat exchanger limits. There may also be a given evaporation rate in the dryer. Changing the dryer may be expensive and in some cases it may represent the limit of the unit. Thus, using the full dryer capacity all the time by using heavier feedstocks when the reactor, heat exchanger, filter or other unit operation that benefits from heavier feedstocks is unable to provide enough product when using methane or light feedstocks to use all of the dryer capacity may increase a production train's profitability.

The amount of the lighter feedstock (e.g., methane) replaced may be meaningful at any level (e.g., even as little as 1% by weight or volume, 2%, 3%, etc. up to 100%, or as otherwise described herein). In an example, once 100% of the methane is replaced with ethane, for example, additional capacity benefits may be achieved by replacing the ethane with a heavier feedstock such as propane, for example, and so forth, on up to heavier and higher molecular weight gases and liquids. In another example, a mixture of heavier feedstocks may be used to replace at least a portion of the lighter feedstock. In yet another example, at least a portion of a first feedstock may be replaced with a second (e.g., heavier) feedstock, and later at least a portion of the first feedstock, or of the first and second feedstock, may be replaced with a third feedstock (e.g., which may be heavier than the first feedstock and lighter than the second feedstock, or which may be lighter than both the first and second feedstock). Thus, the feedstock composition may be varied between lighter and heavier as desired. The amount of a given (e.g., lighter) feedstock replaced may be, for example, greater than or equal to about 0%, 0.001%, 0.005%, 0.01%, 0.05%, 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 99%, 99.5% or 99.9% by weight, volume or mole of the given feedstock. Alternatively, or in addition, the amount of a given (e.g., lighter) feedstock replaced may be, for example, less than or equal to about 100%, 99.9%, 99.5%, 99%, 95%, 90%, 85%, 80%, 75%, 70%, 65%, 60%, 55%, 50%, 45%, 40%, 35%, 30%, 25%, 20%, 15%, 10%, 8%, 6%, 5%, 4%, 3%, 2%, 1%, 0.9%, 0.8%, 0.7%, 0.6%, 0.5%, 0.4%, 0.3%, 0.2%, 0.1%, 0.05%, 0.01%, 0.005% or 0.001% by weight, volume or mole of the given feedstock.

The ability to advantageously replace or mix different feedstocks may provide feedstock flexibility. A heavier feedstock may in some cases be used to replace at least a portion of a lighter feedstock, for example, when availability of the lighter feedstock decreases. Feedstock flexibility may in some cases allow multiple feedstocks to be used interchangeably, thereby ensuring adequate feedstock supply (e.g., redundancy in situations in which a given feedstock is not available). A feedstock mixture may in some cases be used instead of a pure feedstock, for example, when availability of the pure feedstock decreases. Feedstock flexibility may accommodate variability in feedstock supply (e.g., changing composition of natural gas, and/or other feedstocks such as, for example, landfill/waste gas, refinery gas streams (e.g., refinery off-gas), coal bed methane, etc.). If a given (e.g., heavier) feedstock is desired, it may be provided separately or converted from another (e.g., lighter) feedstock. Such feedstock conversion may be provided as part of the systems and methods described herein. The systems (e.g., apparatuses) and methods of the present disclosure, and processes implemented with the aid of the systems and methods herein, may be configured to allow the use of one or more different feedstocks.

A hydrocarbon feedstock (also “feedstock” herein) may comprise a feedstock mixture. The feedstock may comprise a first feedstock (e.g., methane or natural gas) and one or more additional (e.g., second, third, fourth, fifth, etc.) feedstocks (e.g., ethane, propane, butane, pentane, benzene, toluene, xylene, ethylbenzene, naphthalene, methyl naphthalene, dimethyl naphthalene, anthracene, methyl anthracene, other monocyclic or polycyclic aromatic hydrocarbons, carbon black oil, diesel oil, pyrolysis fuel oil, coal tar, crude coal tar, coal, heavy oil, oil, bio-oil, bio-diesel, other biologically derived hydrocarbons, ethylene, acetylene, propylene, butadiene, styrene, ethanol, methanol, propanol, phenol, one or more ketones, one or more ethers, one or more esters, one or more aldehydes, or any combination thereof). A given feedstock (e.g., the first feedstock, the second feedstock, the third feedstock, the fourth feedstock, the fifth feedstock, etc.) may itself comprise a mixture (e.g., such as natural gas). The feedstock may comprise at least one of the one or more additional feedstocks without the first feedstock (e.g., the feedstock may comprise ethane, ethylene, carbon black oil, pyrolysis fuel oil, coal tar, crude coal tar or heavy oil). The feedstock may comprise the first feedstock (e.g., methane or natural gas) at a concentration greater than or equal to about 1 ppm, 5 ppm, 10 ppm, 25 ppm, 50 ppm, 0.01%, 0.05%, 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.5%, 3%, 3.5%, 4%, 4.5%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 55%, 60%, 65%, 70%, 75%, 80%, 85%, 90%, 95% or 99% by weight, volume or mole. As an alternative, the feedstock may comprise the first feedstock (e.g., methane or natural gas) at a concentration less than about 99%, 95%, 90%, 85%, 80%, 75%, 70%, 65%, 60%, 55%, 50%, 49%, 48%, 47%, 46%, 45%, 44%, 43%, 42%, 41%, 40%, 39%, 38%, 37%, 36%, 35%, 34%, 33%, 32%, 31%, 30%, 29%, 28%, 27%, 26%, 25%, 24%, 23%, 22%, 21%, 20%, 19%, 18%, 17%, 16%, 15%, 14%, 13%, 12%, 11%, 10%, 9%, 8%, 7%, 6%, 5%, 4.5%, 4%, 3.5%, 3%, 2.5%, 2%, 1.9%, 1.8%, 1.7%, 1.6%, 1.5%, 1.4%, 1.3%, 1.2%, 1.1%, 1%, 0.9%, 0.8%, 0.7%, 0.6%, 0.5%, 0.4%, 0.3%, 0.2%, 0.1%, 0.05%, 0.01%, 50 ppm, 25 ppm, 10 ppm, 5 ppm or 1 ppm by weight, volume or mole. The feedstock may comprise various levels of the additional feedstock(s). For example, the feedstock may comprise a second feedstock and a third feedstock. The feedstock may comprise the second feedstock (e.g., ethane) at a concentration greater than or equal to about 1 ppm, 5 ppm, 10 ppm, 25 ppm, 50 ppm, 0.01%, 0.05%, 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.5%, 3%, 3.5%, 4%, 4.5%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 55%, 60%, 65%, 70%, 75%, 80%, 85%, 90%, 95% or 99% by weight, volume or mole. As an alternative, the feedstock may comprise the second feedstock (e.g., ethane) at a concentration less than about 99%, 95%, 90%, 85%, 80%, 75%, 70%, 65%, 60%, 55%, 50%, 49%, 48%, 47%, 46%, 45%, 44%, 43%, 42%, 41%, 40%, 39%, 38%, 37%, 36%, 35%, 34%, 33%, 32%, 31%, 30%, 29%, 28%, 27%, 26%, 25%, 24%, 23%, 22%, 21%, 20%, 19%, 18%, 17%, 16%, 15%, 14%, 13%, 12%, 11%, 10%, 9%, 8%, 7%, 6%, 5%, 4.5%, 4%, 3.5%, 39%, 2.5%, 2%, 1.9%, 1.8%, 1.7%, 1.6%, 1.5%, 1.4%, 1.3%, 1.2%, 1.1%, 1%, 0.9%, 0.8%, 0.7%, 0.6%, 0.5%, 0.4%, 0.3%, 0.2%, 0.1%, 0.05%, 0.01%, 50 ppm, 25 ppm, 10 ppm, 5 ppm or 1 ppm by weight, volume or mole. The feedstock may comprise the second feedstock in combination with at least the third feedstock (e.g., propane, butane, pentane, benzene, toluene, xylene, ethylbenzene, naphthalene, methyl naphthalene, dimethyl naphthalene, anthracene, methyl anthracene, other monocyclic or polycyclic aromatic hydrocarbons, carbon black oil, diesel oil, pyrolysis fuel oil, coal tar, crude coal tar, coal, heavy oil, oil, bio-oil, bio-diesel, other biologically derived hydrocarbons, ethylene, acetylene, propylene, butadiene, styrene, ethanol, methanol, propanol, phenol, one or more ketones, one or more ethers, one or more esters or one or more aldehydes), the third feedstock being at a concentration greater than or equal to about 1 ppm, 5 ppm, 10 ppm, 25 ppm, 50 ppm, 0.01%, 0.05%, 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.5%, 3%, 3.5%, 4%, 4.5%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 55%, 60%, 65%, 70%, 75%, 80%, 85%, 90%, 95% or 99% by weight, volume or mole. As an alternative, the feedstock may comprise the second feedstock in combination with at least the third feedstock (e.g., propane, butane, pentane, benzene, toluene, xylene, ethylbenzene, naphthalene, methyl naphthalene, dimethyl naphthalene, anthracene, methyl anthracene, other monocyclic or polycyclic aromatic hydrocarbons, carbon black oil, diesel oil, pyrolysis fuel oil, coal tar, crude coal tar, coal, heavy oil, oil, bio-oil, bio-diesel, other biologically derived hydrocarbons, ethylene, acetylene, propylene, butadiene, styrene, ethanol, methanol, propanol, phenol, one or more ketones, one or more ethers, one or more esters or one or more aldehydes), the third feedstock being at a concentration less than about 99%, 95%, 90%, 85%, 80%, 75%, 70%, 65%, 60%, 55%, 50%, 49%, 48%, 47%, 46%, 45%, 44%, 43%, 42%, 41%, 40%, 39%, 38%, 37%, 36%, 35%, 34%, 33%, 32%, 31%, 30%, 29%, 28%, 27%, 26%, 25%, 24%, 23%, 22%, 21%, 20%, 19%, 18%, 17%, 16%, 15%, 14%, 13%, 12%, 11%, 10%, 9%, 8%, 7%, 6%, 5%, 4.5%, 4%, 3.5%, 3%, 2.5%, 2%, 1.9%, 1.8%, 1.7%, 1.6%, 1.5%, 1.4%, 1.3%, 1.2%, 1.1%, 1%, 0.9%, 0.8%, 0.7%, 0.6%, 0.5%, 0.4%, 0.3%, 0.2%, 0.1%, 0.05%, 0.01%, 50 ppm, 25 ppm, 10 ppm, 5 ppm or 1 ppm by weight, volume or mole. The feedstock may comprise the third feedstock without the second feedstock. The second feedstock may be selected, for example, among the aforementioned one or more additional feedstocks (e.g., propane, butane, pentane, benzene, toluene, xylene, ethylbenzene, naphthalene, methyl naphthalene, dimethyl naphthalene, anthracene, methyl anthracene, other monocyclic or polycyclic aromatic hydrocarbons, carbon black oil, diesel oil, pyrolysis fuel oil, coal tar, crude coal tar, coal, heavy oil, oil, bio-oil, bio-diesel, other biologically derived hydrocarbons, ethylene, acetylene, propylene, butadiene, styrene, ethanol, methanol, propanol, phenol, one or more ketones, one or more ethers, one or more esters or one or more aldehydes may be selected instead of ethane). The third feedstock may then be suitably selected from the remainder of the one or more additional feedstocks. The feedstock may comprise other (e.g. fourth, fifth, sixth, seventh, ninth, tenth, 11^{th}, 12^{th}, 13^{th}, 14^{th}, 15^{th}, 16^{th}, 17^{th}, 18^{th}, 19^{th}, 20^{th}, etc.) additional feedstocks (e.g., at similar or different concentrations). Such other additional feedstocks may be selected, for example, among the aforementioned one or more additional feedstocks not selected as the second feedstock and the third feedstock.

The first feedstock and the one or more additional feedstocks (e.g., a second feedstock, a third feedstock, a fourth feedstock, a fifth feedstock, etc.) may be selected among, for example, simple hydrocarbons, aromatic feedstocks, unsaturated hydrocarbons, oxygenated hydrocarbons, or any combination thereof. The feedstock may comprise, for example, one or more of the following combinations: one or more simple hydrocarbons, and one or more aromatic feedstocks; one or more simple hydrocarbons, and one or more unsaturated hydrocarbons; one or more simple hydrocarbons, and one or more oxygenated hydrocarbons; one or more simple hydrocarbons, one or more aromatic feedstocks, and one or more unsaturated hydrocarbons; one or more simple hydrocarbons, one or more aromatic feedstocks, and one or more oxygenated hydrocarbons; one or more simple hydrocarbons, one or more unsaturated hydrocarbons, and one or more oxygenated hydrocarbons; one or more simple hydrocarbons, one or more aromatic feedstocks, one or more unsaturated hydrocarbons, and one or more oxygenated hydrocarbons; one or more aromatic feedstocks, and one or more unsaturated hydrocarbons; one or more aromatic feedstocks, and one or more oxygenated hydrocarbons; one or more aromatic feedstocks, one or more unsaturated hydrocarbons, and one or more oxygenated hydrocarbons; and one or more unsaturated hydrocarbons, and one or more oxygenated hydrocarbons. The first feedstock and the one or more additional feedstocks (e.g., a second feedstock, a third feedstock, a fourth feedstock, a fifth feedstock, etc.) may be selected among, for example, methane, ethane, propane, butane, pentane, natural gas, benzene, toluene, xylene, ethylbenzene, naphthalene, methyl naphthalene, dimethyl naphthalene, anthracene, methyl anthracene, other monocyclic or polycyclic aromatic hydrocarbons, carbon black oil, diesel oil, pyrolysis fuel oil, coal tar, crude coal tar, coal, heavy oil, oil, bio-oil, bio-diesel, other biologically derived hydrocarbons, ethylene, acetylene, propylene, butadiene, styrene, ethanol, methanol, propanol, phenol, one or more ketones, one or more ethers, one or more esters, one or more aldehydes, or any combination thereof. The feedstock may comprise (e.g., the first feedstock and at least one of the one or more additional feedstocks may be), for example, one or more of the following combinations: methane and/or ethylene (e.g., methane; ethylene; or methane and ethylene); methane and/or ethylene, and ethane, propane, butane and/or pentane (e.g., methane and ethane; methane and propane; methane and butane; methane and pentane; methane, ethane and propane; methane, ethane and butane; methane, ethane and pentane; methane, ethane, propane and butane; methane, ethane, propane and pentane; methane, ethane, butane and pentane; methane, ethane, propane, butane and pentane; methane, propane and butane; methane, propane and pentane; methane, propane, butane and pentane; methane, butane and pentane; ethylene and ethane; ethylene and propane; ethylene and butane; ethylene and pentane; ethylene, ethane and propane; ethylene, ethane and butane; ethylene, ethane and pentane; ethylene, ethane, propane and butane; ethylene, ethane, propane and pentane; ethylene, ethane, butane and pentane; ethylene, ethane, propane, butane and pentane; ethylene, propane and butane; ethylene, propane and pentane; ethylene, propane, butane and pentane; ethylene, butane and pentane; methane, ethylene and ethane; methane, ethylene and propane; methane, ethylene and butane; methane, ethylene and pentane; methane, ethylene, ethane and propane; methane, ethylene, ethane and butane; methane, ethylene, ethane and pentane; methane, ethylene, ethane, propane and butane; methane, ethylene, ethane, propane and pentane; methane, ethylene, ethane, butane and pentane; methane, ethylene, ethane, propane, butane and pentane; methane, ethylene, propane and butane; methane, ethylene, propane and pentane; methane, ethylene, propane, butane and pentane; or methane, ethylene, butane and pentane); methane and/or ethylene, and benzene, toluene, xylene and/or naphthalene (e.g., methane and benzene; methane and toluene; methane and xylene; methane and naphthalene; methane, benzene and toluene; methane, benzene and xylene; methane, benzene and naphthalene; methane, toluene and xylene; methane, toluene and naphthalene; methane, xylene and naphthalene; methane, benzene, toluene and xylene; methane, benzene, toluene and naphthalene; methane, benzene, xylene and naphthalene; methane, toluene, xylene and naphthalene; methane, benzene, toluene, xylene and naphthalene; ethylene and benzene; ethylene and toluene; ethylene and xylene; ethylene and naphthalene; ethylene, benzene and toluene; ethylene, benzene and xylene; ethylene, benzene and naphthalene; ethylene, toluene and xylene; ethylene, toluene and naphthalene; ethylene, xylene and naphthalene; ethylene, benzene, toluene and xylene; ethylene, benzene, toluene and naphthalene; ethylene, benzene, xylene and naphthalene; ethylene, toluene, xylene and naphthalene; ethylene, benzene, toluene, xylene and naphthalene; methane, ethylene and benzene; methane, ethylene and toluene; methane, ethylene and xylene; methane, ethylene and naphthalene; methane, ethylene, benzene and toluene; methane, ethylene, benzene and xylene; methane, ethylene, benzene and naphthalene; methane, ethylene, toluene and xylene; methane, ethylene, toluene and naphthalene; methane, ethylene, xylene and naphthalene; methane, ethylene, benzene, toluene and xylene; methane, ethylene, benzene, toluene and naphthalene; methane, ethylene, benzene, xylene and naphthalene; methane, ethylene, toluene, xylene and naphthalene; or methane, ethylene, benzene, toluene, xylene and naphthalene); methane and/or ethylene, and ethylbenzene; methane and/or ethylene, and methyl naphthalene and/or dimethyl naphthalene (e.g., methane and methyl naphthalene; methane and dimethyl naphthalene; methane, methyl naphthalene and dimethyl naphthalene; ethylene and methyl naphthalene; ethylene and dimethyl naphthalene; ethylene, methyl naphthalene and dimethyl naphthalene; methane, ethylene and methyl naphthalene; methane, ethylene and dimethyl naphthalene; or methane, ethylene, methyl naphthalene and dimethyl naphthalene); methane and/or ethylene, and anthracene and/or methyl anthracene (e.g., methane and anthracene; methane and methyl anthracene; methane, anthracene and methyl anthracene); ethylene and anthracene; ethylene and methyl anthracene; ethylene, anthracene and methyl anthracene; methane, ethylene and anthracene; methane, ethylene and methyl anthracene; or methane, ethylene, anthracene and methyl anthracene); methane and/or ethylene, and carbon black oil; methane and/or ethylene, and pyrolysis fuel oil; methane and/or ethylene, and coal tar; methane and/or ethylene, and crude coal tar; methane and/or ethylene, and heavy oil; methane and/or ethylene, and acetylene; methane and/or ethylene, and propylene; methane and/or ethylene, and butadiene; methane and/or ethylene, and styrene; methane and/or ethylene, and methanol, ethanol and/or propanol (e.g., methane and methanol; methane and ethanol; methane and propanol; methane, methanol and ethanol; methane, methanol and propanol; methane, ethanol and propanol; methane, methanol, ethanol and propanol; ethylene and methanol; ethylene and ethanol; ethylene and propanol; ethylene, methanol and ethanol; ethylene, methanol and propanol; ethylene, ethanol and propanol; ethylene, methanol, ethanol and propanol; methane, ethylene and methanol; methane, ethylene and ethanol; methane, ethylene and propanol; methane, ethylene, methanol and ethanol; methane, ethylene, methanol and propanol; methane, ethylene, ethanol and propanol; or methane, ethylene, methanol, ethanol and propanol); methane and/or ethylene, and phenol; methane and/or ethylene, and one or more ketones; methane and/or ethylene, and one or more ethers; methane and/or ethylene, and one or more esters; methane and/or ethylene, and one or more aldehydes; natural gas, and benzene, toluene, xylene and/or naphthalene (e.g., natural gas and benzene; natural gas and toluene; natural gas and xylene; natural gas and naphthalene; natural gas, benzene and toluene; natural gas, benzene and xylene; natural gas, benzene and naphthalene; natural gas, toluene and xylene; natural gas, toluene and naphthalene; natural gas, xylene and naphthalene; natural gas, benzene, toluene and xylene; natural gas, benzene, toluene and naphthalene; natural gas, benzene, xylene and naphthalene; natural gas, toluene, xylene and naphthalene; or natural gas, benzene, toluene, xylene and naphthalene); natural gas and ethylbenzene; natural gas, and methyl naphthalene and/or dimethyl naphthalene (e.g., natural gas and methyl naphthalene; natural gas and dimethyl naphthalene; or natural gas, methyl naphthalene and dimethyl naphthalene); natural gas, and anthracene and/or methyl anthracene (e.g., natural gas and anthracene; natural gas and methyl anthracene; or natural gas, anthracene and methyl anthracene); natural gas and carbon black oil; natural gas and pyrolysis fuel oil; natural gas and coal tar; natural gas and crude coal tar; natural gas and heavy oil; natural gas and ethylene; natural gas and acetylene; natural gas and propylene; natural gas and butadiene; natural gas and styrene; natural gas, and methanol, ethanol and/or propanol (e.g., natural gas and methanol; ethanol; natural gas and propanol; natural gas, methanol and ethanol; natural gas, methanol and propanol; natural gas, ethanol and propanol; or natural gas, methanol, ethanol and propanol); natural gas and phenol; natural gas, and one or more ketones; natural gas, and one or more ethers; natural gas, and one or more esters; natural gas, and one or more aldehydes; ethane, propane, butane and/or pentane (e.g., ethane; propane; butane; pentane; ethane and propane; ethane and butane; ethane and pentane; ethane, propane and butane; ethane, propane and pentane; ethane, butane and pentane; ethane, propane, butane and pentane; propane and butane; propane and pentane; propane, butane and pentane; or butane and pentane); ethane, propane, butane and/or pentane, and benzene, toluene, xylene and/or naphthalene; ethane, propane, butane and/or pentane, and ethylbenzene; ethane, propane, butane and/or pentane, and methyl naphthalene and/or dimethyl naphthalene; ethane, propane, butane and/or pentane, and anthracene and/or methyl anthracene; ethane, propane, butane and/or pentane, and carbon black oil; ethane, propane, butane and/or pentane, and pyrolysis fuel oil; ethane, propane, butane and/or pentane, and coal tar; ethane, propane, butane and/or pentane, and crude coal tar; ethane, propane, butane and/or pentane, and heavy oil; ethane, propane, butane and/or pentane, and acetylene; ethane, propane, butane and/or pentane, and propylene; ethane, propane, butane and/or pentane, and butadiene; ethane, propane, butane and/or pentane, and styrene; ethane, propane, butane and/or pentane, and methanol, ethanol and/or propanol; ethane, propane, butane and/or pentane, and phenol; ethane, propane, butane and/or pentane, and one or more ketones; ethane, propane, butane and/or pentane, and one or more ethers; ethane, propane, butane and/or pentane, and one or more esters; ethane, propane, butane and/or pentane, and one or more aldehydes; benzene, toluene, xylene and/or naphthalene (e.g., benzene; toluene; xylene; naphthalene; benzene and toluene; benzene and xylene; benzene and naphthalene; toluene and xylene; toluene and naphthalene; xylene and naphthalene; benzene, toluene and xylene; benzene, toluene and naphthalene; benzene, xylene and naphthalene; toluene, xylene and naphthalene; or benzene, toluene, xylene and naphthalene); benzene, toluene, xylene and/or naphthalene, and ethylbenzene; benzene, toluene, xylene and/or naphthalene, and methyl naphthalene and/or dimethyl naphthalene; benzene, toluene, xylene and/or naphthalene, and anthracene and/or methyl anthracene; benzene, toluene, xylene and/or naphthalene, and acetylene; benzene, toluene, xylene and/or naphthalene, and propylene; benzene, toluene, xylene and/or naphthalene, and butadiene; benzene, toluene, xylene and/or naphthalene, and styrene; benzene, toluene, xylene and/or naphthalene, and methanol, ethanol and/or propanol; benzene, toluene, xylene and/or naphthalene, and phenol; benzene, toluene, xylene and/or naphthalene, and one or more ketones; benzene, toluene, xylene and/or naphthalene, and one or more ethers; benzene, toluene, xylene and/or naphthalene, and one or more esters; benzene, toluene, xylene and/or naphthalene, and one or more aldehydes; ethylbenzene, and methyl naphthalene and/or dimethyl naphthalene; ethylbenzene, and anthracene and/or methyl anthracene; ethylbenzene and acetylene; ethylbenzene and propylene; ethylbenzene and butadiene; ethylbenzene and styrene; ethylbenzene, and methanol, ethanol and/or propanol; ethylbenzene and phenol; ethylbenzene, and one or more ketones; ethylbenzene, and one or more ethers; ethylbenzene, and one or more esters; ethylbenzene, and one or more aldehydes; methyl naphthalene and/or dimethyl naphthalene (e.g., methyl naphthalene; dimethyl naphthalene; or methyl naphthalene and dimethyl naphthalene); methyl naphthalene and/or dimethyl naphthalene, and anthracene and/or methyl anthracene; methyl naphthalene and/or dimethyl naphthalene, and acetylene; methyl naphthalene and/or dimethyl naphthalene, and propylene; methyl naphthalene and/or dimethyl naphthalene, and butadiene; methyl naphthalene and/or dimethyl naphthalene, and styrene; methyl naphthalene and/or dimethyl naphthalene, and methanol, ethanol and/or propanol; methyl naphthalene and/or dimethyl naphthalene, and phenol; methyl naphthalene and/or dimethyl naphthalene, and one or more ketones; methyl naphthalene and/or dimethyl naphthalene, and one or more ethers; methyl naphthalene and/or dimethyl naphthalene, and one or more esters; methyl naphthalene and/or dimethyl naphthalene, and one or more aldehydes; anthracene and/or methyl anthracene (e.g., anthracene; methyl anthracene; or anthracene and methyl anthracene); anthracene and/or methyl anthracene, and acetylene; anthracene and/or methyl anthracene, and propylene; anthracene and/or methyl anthracene, and butadiene; anthracene and/or methyl anthracene, and styrene; anthracene and/or methyl anthracene, and methanol, ethanol and/or propanol; anthracene and/or methyl anthracene, and phenol; anthracene and/or methyl anthracene, and one or more ketones; anthracene and/or methyl anthracene, and one or more ethers; anthracene and/or methyl anthracene, and one or more esters; anthracene and/or methyl anthracene, and one or more aldehydes; acetylene and propylene; acetylene and butadiene; acetylene and styrene; acetylene, and methanol, ethanol and/or propanol; acetylene and phenol; acetylene, and one or more ketones; acetylene, and one or more ethers; acetylene, and one or more esters; acetylene, and one or more aldehydes; acetylene and carbon black oil; acetylene and pyrolysis fuel oil; acetylene and coal tar; acetylene and crude coal tar; acetylene and heavy oil; propylene and butadiene; propylene and styrene; propylene, and methanol, ethanol and/or propanol; propylene and phenol; propylene, and one or more ketones; propylene, and one or more ethers; propylene, and one or more esters; propylene, and one or more aldehydes; propylene and carbon black oil; propylene and pyrolysis fuel oil; propylene and coal tar; propylene and crude coal tar; propylene and heavy oil; butadiene and styrene; butadiene, and methanol, ethanol and/or propanol; butadiene and phenol; butadiene, and one or more ketones; butadiene, and one or more ethers; butadiene, and one or more esters; butadiene, and one or more aldehydes; butadiene and carbon black oil; butadiene and pyrolysis fuel oil; butadiene and coal tar; butadiene and crude coal tar; butadiene and heavy oil; styrene, and methanol, ethanol and/or propanol; styrene and phenol; styrene, and one or more ketones; styrene, and one or more ethers; styrene, and one or more esters; styrene, and one or more aldehydes; styrene and carbon black oil; styrene and pyrolysis fuel oil; styrene and coal tar; styrene and crude coal tar; styrene and heavy oil; methanol, ethanol and/or propanol (e.g., methanol; ethanol; propanol; methanol and ethanol; methanol and propanol; ethanol and propanol; or methanol, ethanol and propanol); methanol, ethanol and/or propanol, and phenol; methanol, ethanol and/or propanol, and one or more ketones; methanol, ethanol and/or propanol, and one or more ethers; methanol, ethanol and/or propanol, and one or more esters; methanol, ethanol and/or propanol, and one or more aldehydes; methanol, ethanol and/or propanol, and carbon black oil; methanol, ethanol and/or propanol, and pyrolysis fuel oil; methanol, ethanol and/or propanol, and coal tar; methanol, ethanol and/or propanol, and crude coal tar; methanol, ethanol and/or propanol, and heavy oil; phenol, and one or more ketones; phenol, and one or more ethers; phenol, and one or more esters; phenol, and one or more aldehydes; one or more ketones, and one or more ethers; one or more ketones, and one or more esters; one or more ketones, and one or more aldehydes; one or more ketones, and carbon black oil; one or more ketones, and pyrolysis fuel oil; one or more ketones, and coal tar; one or more ketones, and crude coal tar; one or more ketones, and heavy oil; one or more ethers, and one or more esters; one or more ethers, and one or more aldehydes; one or more ethers, and carbon black oil; one or more ethers, and pyrolysis fuel oil; one or more ethers, and coal tar; one or more ethers, and crude coal tar; one or more ethers, and heavy oil; one or more esters, and one or more aldehydes; one or more esters and carbon black oil; one or more esters, and pyrolysis fuel oil; one or more esters, and coal tar; one or more esters, and crude coal tar; one or more esters, and heavy oil; one or more aldehydes, and carbon black oil; one or more aldehydes, and pyrolysis fuel oil; one or more aldehydes, and coal tar; one or more aldehydes, and crude coal tar; one or more aldehydes, and heavy oil; and carbon black oil, pyrolysis fuel oil, coal tar, crude coal tar and/or heavy oil (e.g., carbon black oil and pyrolysis fuel oil; carbon black oil and coal tar; carbon black oil and crude coal tar; carbon black oil and heavy oil; pyrolysis fuel oil and coal tar; pyrolysis fuel oil and crude coal tar; pyrolysis fuel oil and heavy oil; coal tar and heavy oil; crude coal tar and heavy oil; carbon black oil, pyrolysis fuel oil and coal tar; carbon black oil, pyrolysis fuel oil and crude coal tar; carbon black oil, pyrolysis fuel oil and heavy oil; carbon black oil, coal tar and heavy oil; carbon black oil, crude coal tar and heavy oil; pyrolysis fuel oil, coal tar and heavy oil; pyrolysis fuel oil, crude coal tar and heavy oil; coal tar, crude coal tar and heavy oil; carbon black oil, pyrolysis fuel oil, coal tar and heavy oil; carbon black oil, pyrolysis fuel oil, crude coal tar and heavy oil). In addition to, or in place of, the aforementioned combinations, other combinations (e.g., combinations where at least one component, or an individual compound thereof, in the aforementioned combinations may be substituted for another component, or an individual compound thereof) may be used (e.g., combinations comprising other feedstocks described herein, such as, for example, combinations comprising other monocyclic or polycyclic aromatic hydrocarbons, diesel oil, coal, oil, bio-oil, bio-diesel and/or other biologically derived hydrocarbons). The aforementioned combinations may comprise at least a first component (e.g., a single compound or a mixture of compounds). The aforementioned combinations may comprise at least a first component (e.g., a single compound or a mixture of compounds) and a second component (e.g., a single compound or a mixture of compounds). The feedstock may comprise the first component, or an individual compound thereof, at a concentration (e.g., individual or total concentration) which may be, for example, as described herein in relation to a concentration of the first feedstock, the second feedstock or the third feedstock. The feedstock may comprise the second component, or an individual compound thereof, at a concentration (e.g., individual or total concentration) which may be, for example, as described herein in relation to a concentration of the first feedstock, the second feedstock or the third feedstock. The feedstock may comprise one or more of the aforementioned combinations in concert (e.g., the feedstock may comprise a combination of one or more of the aforementioned combinations). For example, the feedstock may comprise (e.g., two, three or more of) a first component of a first combination, a second component of a first combination, a first component of a second combination, a second component of a second combination, etc. (e.g., a component may be combined with methane only, with methane together with ethane, propane, butane and/or pentane, with natural gas in place of methane, or with another suitable mixture comprising methane described herein; one or more combinations with a common component (such as, for example, a common second component) may be combined; etc.). The first combination, the second combination, etc. may be referred to herein as subcombinations (e.g., in the context of a combination of one or more subcombinations). The feedstock may comprise a given component of such a combination of subcombinations, or an individual compound thereof, at a concentration (e.g., individual or total concentration) which may be, for example, as described herein in relation to a concentration of the first feedstock, the second feedstock or the third feedstock. Alternatively, each subcombination may comprise its respective components, or individual compounds thereof, at given concentrations, and the subcombinations may be combined at given proportions. A combination may comprise, for example, greater than or equal to about 1%, 2%, 3%, 4%, 5%, 10%, 15%, 20%, 25%, 30%, 35%, 40%, 45%, 50%, 55%, 60%, 65%, 70%, 75%, 80%, 85%, 90%, 95% or 99% of a given subcombination (with balance made up by remaining subcombinations). Alternatively, or in addition, the combination may comprise, for example, less than or equal to about 100%, 99%, 95%, 90%, 85%, 80%, 75%, 70%, 65%, 60%, 55%, 50%, 45%, 40%, 35%, 30%, 25%, 20%, 15%, 10%, 5%, 4%, 3% or 2%. 1%, 2%, 3%, 4%, 5%, 10%, 15%, 20%, 25%, 30%, 35%, 40%, 45%, 50%, 55%, 60%, 65%, 70%, 75%, 80%, 85%, 90%, 95% or 99% of the given subcombination (with balance made up by remaining subcombinations). A final concentration of a component of a subcombination, or an individual compound thereof, in a combination of subcombinations may be, for example, its concentration in the subcombination altered by combining with other subcombination(s), its concentration in the subcombination (e.g., the concentration in a subcombination may apply to the concentration in the combination of subcombinations), or its concentration in another subcombination (e.g., when multiple subcombinations comprise a common component, or an individual compound thereof, the concentration in any of the subcombinations may apply to the concentration in the combination of subcombinations).

At least a portion of the feedstock may be further converted or generated by conversion from another feedstock. Such conversion may be on demand and/or on site. At least a portion (e.g., which may be, for example, as described herein in relation to the amount of a given (e.g., lighter) feedstock replaced) of the feedstock may be further converted or generated through (e.g., the conversion may include), for example, greater than or equal to 1, 2, 3, 4, 5, 6, 7, 8, 9, 10, 12, 14, 16, 18, 20, 22, 24, 26, 28, 30, 35, 40, 45 or 50 conversion steps or stages. Alternatively, or in addition, at least a portion (e.g., which may be, for example, as described herein in relation to the amount of a given (e.g., lighter) feedstock replaced) of the feedstock may be further converted or generated through (e.g., the conversion may include), for example, less than or equal to 50, 45, 40, 35, 30, 28, 26, 24, 22, 20, 18, 16, 14, 12, 10, 9, 8, 7, 6, 5, 4, 3 or 2 conversion steps or stages. The conversion may include, for example, one or more (e.g., any combination) of: catalytic conversion, thermal conversion, catalytic reforming, catalytic cracking (e.g., hydrocracking), steam cracking (e.g., of ethane, propane and/or butane), pyrolysis, steam reforming, dry reforming, partial/direct oxidation, oxidative coupling, reductive coupling, dehydrocyclization, dehydroaromatization, aromatization, methanation, ethanation, activation with a halogen (e.g., halogenation using fluorination, chlorination, bromination and/or iodination), oxygen and/or sulfur (e.g., over a suitable catalyst and/or followed by suitable catalytic conversion), conversion in the presence of oxygen, conversion in the absence of oxygen, synthesis gas generation, synthesis gas conversion (e.g., Fischer-Tropsch conversion), separation (e.g., separation of gases from each other, separation of gases from liquids, distillation, etc.), extraction, enrichment, isomerization, disproportionation, transalkylation, alkylation, dealkylation (e.g., hydrodealkylation), hydrogenation, dehydrogenation, activation, and any other suitable (e.g., petrochemical) conversion method(s) (e.g., as separate steps or stages, or in various combinations with each other). One or more of such steps or stages may be performed in the presence of a catalyst (e.g., heterogeneous catalyst), and may utilize, for example, one or more metals, one or more metal carbides, one or more metal oxycarbides, one or more metal oxides, zeolite (e.g., used as catalyst or support), aluminosilicates and/or other inorganic materials (e.g., used as catalyst or support), support modification (e.g., using phosphorus-containing alumina), or any combination thereof (e.g., metal supported on zeolite). The composition of the feedstock input to the conversion may in some cases be suitably tuned (e.g., a given amount of an additional compound may be added and/or a concentration of an already present compound may be increased or decreased) to achieve a given conversion (e.g., to achieve suitable performance, such as, for example, to achieve a given degree of conversion, to decrease or eliminate catalyst fouling and/or coking, etc.). Feedstock conversion may in some cases be used to convert a given component of a feedstock to a more suitable component (e.g., minor components may be upgraded, suppressed or enhanced). The conversion may be used, for example, to produce a heavier (e.g., higher carbon content/number) feedstock (e.g., in order to replace at least a portion of a given feedstock with the heavier feedstock, as described in greater detail elsewhere herein), to convert at least a portion (e.g., all) of a given feedstock to another (e.g., heavier, or lighter) feedstock (e.g., ethane to ethylene; ethane to methane; ethylene, propylene or butadiene to one or more other feedstocks; etc.), to produce a given feedstock from an unsuitable feedstock, etc. For example, methane or natural gas may be converted (e.g., catalytically) to one or more paraffins (e.g., ethane), one or more olefins (e.g., ethylene and/or higher olefins), one or more aromatic compounds (e.g., benzene, toluene and/or xylene, and/or naphthalene), one or more C₃-C₄ hydrocarbons, and/or one or more C₅-C₁₀ hydrocarbons (e.g., oxidative coupling of methane may be used to produce one or more olefins (e.g., which may in turn be catalytically converted to one or more liquid hydrocarbons); one or more olefins may be catalytically converted to heavier hydrocarbons; dehydroaromatization, dehydrocyclization or reductive coupling of methane may be used to produce, for example, ethylene, benzene and/or naphthalene; natural gas may be converted to liquids using a methane coupling method of synthesis; natural gas may be converted to aromatics, butane and/or pentane, propylene, butadiene, ethylbenzene/styrene, and/or other compounds (e.g., other liquids) through, for example, halogenation (e.g., bromination) to methyl bromide, synthesis conversion to suitable hydrocarbon(s) (e.g., liquids, fuel, etc.) and HBr, HBr conversion to Br₂, and/or product separation; or any combination thereof). The conversion may include, for example, one or more steps or stages including, for example, separation (e.g., of product from byproduct or of a given byproduct from another byproduct, such as, for example, separation using distillation, condensation, sorption, pressure or thermal swing adsorption, membrane separation, solvent extraction, fractionation, crystallization and/or other methods), recycling (e.g., of a byproduct or incompletely converted product, such as, for example, a stream comprising paraffins, olefins and/or aromatic species, to a main conversion stage; recycling of a reactant, such as, for example, recycling an activation species such as a halogen; or any combination thereof), rejection (e.g., of waste stream or byproduct), byproduct or intermediate product conversion (e.g., using one or more conversion methods described elsewhere herein, such as, for example, conversion of byproduct hydrogen or intermediate hydrocarbons (e.g., methanol) to one or more other hydrocarbons), combination of product, byproduct and/or intermediate streams and/or reactant addition to such stream(s) (e.g., additional reactant may be added to a product, byproduct and/or intermediate stream to achieve byproduct or intermediate product conversion to, for example, one or more suitable hydrocarbons, and/or to achieve further product conversion; byproduct or intermediate streams may be suitably combined for further conversion; a byproduct stream (which may itself be produced in a preceding conversion step or stage, for example, from another byproduct) may be suitably combined with a product stream to further convert the product stream; a product or byproduct stream (e.g., methanol or ethylene) may be further converted to distillates, condensates, aromatics and/or other hydrocarbon(s); or any combination thereof), other processing (e.g., combustion or sequestration of waste stream or byproduct), regeneration (e.g., of a catalyst or an activation species such as a halogen), or any combination thereof. A material stream such as, for example, a product, byproduct and/or intermediate stream may refer to a pure stream of the respective material (e.g., after separation), or to a stream comprising a mixture that comprises the respective material (e.g., prior to separation). A given conversion step or stage of the conversion may be performed at a suitable temperature, pressure and/or other conditions (e.g., which may in some cases include heating or cooling a given material stream before, during and/or after the given conversion step or stage). A given conversion step or stage may be suitably configured (e.g., a solid phase, such as, for example, zeolite, activated carbon, molecular sieve, catalyst, etc., used in some separations and/or during conversion in the presence of a catalyst may be configured, for example, in fixed bed, packed bed, settling bed, cascaded fluid bed, fluidized bed, membrane, or transport or riser configurations; a given step or stage may be performed, for example, in vapor phase and/or liquid phase (e.g., in combination with a solid phase comprising solid catalyst); etc.). A converted portion of a given feedstock may be used as a feedstock. A converted portion of a given feedstock may be combined with an unconverted or bypassed portion of the same feedstock, or with a different feedstock. A converted portion may comprise only a given set of conversion products (e.g., no byproducts or unconverted feedstock). A converted portion may comprise a conversion mixture (e.g., unseparated mixture comprising unconverted feedstock, one or more products and/or one or more byproducts). Conversion steps or stages may be added or removed to achieve a suitable composition of the converted portion (e.g., recycling, separation and/or byproduct conversion steps or stages may be added or removed). The conversion may achieve suitable performance (e.g., degree of conversion, yield, selectivity, operating life, etc.). At least a subset of such parameters may be adjusted, and/or conversion steps or stages may be added, removed and/or (re)combined, to achieve given conversion output composition(s).

At least a portion of a first material stream may be provided to a first conversion step or stage. A remaining portion of the first material stream may be, for example, converted separately from the first conversion step or stage (e.g., through a different conversion), provided to a second conversion step or stage, used in a different process, or any combination thereof. The first conversion step or stage may be omitted or bypassed (e.g., on demand). At least a portion of the first material provided to the first conversion step or stage may be converted in the first conversion step or stage. One or more additional material streams (e.g., at least one ninth material stream) may be provided to the first conversion step or stage in addition to the first material stream. The first material stream provided to the first conversion step or stage may be provided all at once, or gradually (e.g., some may be provided at a later point in the first conversion step or stage, for example, to stage reaction, to react with intermediate products and/or byproducts, etc.). The first material stream may be a feedstock. The first material stream may have a composition as described elsewhere herein (e.g., in relation to feedstock compositions). The first material stream may comprise one or more hydrocarbons. The first material stream may comprise at least about 70% by weight methane, ethane, propane or mixtures thereof. The first material stream may comprise methane. The first material stream may comprise natural gas. The first material stream may comprise a refinery stream or off-gas. The first conversion step or stage may itself comprise one or more conversion steps or stages. The first conversion step or stage may comprise one or more feedstock conversion steps or stages (e.g., which may be as described elsewhere herein). The first conversion step or stage may comprise or be, for example, a catalytic and thermal conversion step or stage. The first conversion step or stage may comprise or be, for example, a thermocatalytic conversion step or stage. The first conversion step or stage may include or be a refining (e.g., petrochemical refining) step or stage (e.g., the first conversion step or stage may be performed at a refinery). At least a portion of the first material stream may be converted (e.g., in the first conversion step or stage) to a second material stream. The second material stream may comprise a refinery stream or off-gas. The second material stream may comprise a pure stream of a given material, which may itself comprise one or more compounds, or a stream comprising a mixture that comprises the given material. The second material stream may comprise, for example, a converted portion (e.g., which may be as described elsewhere herein). The second material stream may comprise a given set of conversion products (e.g., one or more compounds). The conversion product(s) may be separated from other components of the conversion output (e.g., byproduct(s), intermediate product(s), unconverted material, etc.). One or more such components of the conversion may be provided from the first conversion step or stage (e.g., as at least one seventh material stream) for use elsewhere, for separate conversion, for recycling back into the first conversion step or stage (e.g., unconverted material may be recycled back), or any combination thereof. The conversion product(s) may not be separated from at least a portion of the other components of the conversion output (e.g., byproduct(s), intermediate product(s), unconverted material, etc.). The second material stream may comprise a given set of conversion products (e.g., one or more compounds) in combination with a given set of byproducts (e.g., one or more compounds). The second material stream may comprise a given set of conversion products (e.g., one or more compounds) in combination with a given set of intermediate products (e.g., one or more compounds). The second material stream may comprise a given set of conversion products (e.g., one or more compounds) in combination with unconverted material (e.g., in combination with the first material). The second material stream may comprise a given set of conversion products (e.g., one or more compounds), byproducts (e.g., one or more compounds), intermediate products (e.g., one or more compounds), and/or unconverted material. At least a portion (e.g., all) of the second material stream may be provided to the second conversion step or stage. A remaining portion of the second material stream may be stored, used in a different process, or used elsewhere in a system according to the present disclosure (e.g., see FIGS. 1 and 2). Alternatively, or in addition, one or more additional material streams (e.g., at least one eighth material stream) may be provided to the second conversion step or stage. At least a subset of the material stream(s) provided to the second conversion step or stage (e.g., the first material stream, the second material stream, and/or the at least one eighth material stream) may be feedstock(s) (e.g., a lighter and a heavier feedstock). At least a subset of the material stream(s) provided to the second conversion step or stage (e.g., the first material stream, the second material stream, and/or the at least one eighth material stream) may have (e.g., individually or in combination) composition(s) as described elsewhere herein (e.g., in relation to feedstock compositions). For example, the second material stream may comprise methane, natural gas, ethane, propane, butane, pentane, benzene, toluene, xylene, ethylbenzene, naphthalene, methyl naphthalene, dimethyl naphthalene, anthracene, methyl anthracene, carbon black oil, pyrolysis fuel oil, coal tar, crude coal tar, heavy oil, ethylene, acetylene, propylene, butadiene, styrene, ethanol, methanol, propanol, phenol, one or more ketones, one or more ethers, one or more esters, one or more aldehydes, or any combination thereof. The second conversion step or stage may itself comprise one or more conversion steps or stages. The second conversion step or stage may comprise one or more particle generating steps or stages (e.g., which may be as described elsewhere herein). The second conversion step or stage may comprise or be, for example, a thermal conversion step or stage (e.g., performed in a thermal carbon particle (e.g., carbon black) reactor). The second conversion step or stage may include generating a fifth material stream (e.g., carbon particles, such as, for example, carbon black). The second conversion step or stage may include heating a third material stream. Alternatively, or in addition, the third material stream may be at least in part heated separately from (e.g., prior to) the second conversion step or stage. The third material stream may be a thermal transfer gas. The third material stream may have a composition as described elsewhere herein (e.g., in relation to thermal gas compositions). The third material stream may comprise greater than about 60% hydrogen. The second conversion step or stage may include heating the third material stream, and generating the fifth material stream (e.g., carbon particles, such as, for example, carbon black). The fifth material stream (e.g., carbon particles, such as, for example, carbon black) may be generated in a reactor. The reactor may be as described elsewhere herein (e.g., in relation to FIGS. 1 and 2). The fifth material stream (e.g., carbon particles, such as, for example, carbon black) may be generated in a reactor comprising the third material stream and at least one of the first material stream and the second material stream. At least a portion of the material stream(s) provided to the second conversion step or stage (e.g., the first material stream, the second material stream, and/or the at least one eighth material stream) may be converted (e.g., in the second conversion step or stage) to the fifth material stream (e.g., carbon particles, such as, for example, carbon black). The second conversion step or stage may output (e.g., produce or generate) a fourth material stream. The fourth material stream may comprise at least another portion of the material stream(s) provided to the second conversion step or stage (e.g., the first material stream, the second material stream, and/or the at least one eighth material stream). The fourth material stream may comprise at least a portion of the third material stream. The fourth material stream may comprise hydrogen. The fourth material stream and the fifth material stream (e.g., carbon particles, such as, for example, carbon black) may be (e.g., at least in part) separated from each other in a third conversion step or stage. The third conversion step or stage may comprise a filtering step or stage (e.g., performed using a filter, such as, for example filter 104 or 214). One or more properties of the fourth material stream before the third conversion step or stage may differ from its respective properties after the third conversion step or stage (e.g., as described elsewhere herein). One or more properties of the fifth material stream (e.g., carbon particles, such as, for example, carbon black) before the third conversion step or stage may differ from its respective properties after the third conversion step or stage (e.g., as described elsewhere herein). The third conversion step or stage may comprise or be followed by one or more other steps or stages (e.g., which may be as described elsewhere herein, for example, in relation to FIGS. 1 and 2). The fifth material stream (e.g., carbon particles, such as, for example, carbon black) may be further processed (e.g., as described herein in relation to FIGS. 1 and 2). At least a portion of the fourth material stream from the third conversion step or stage may be recycled to the second conversion step or stage as the third material stream (e.g., as is, or further combined with at least one sixth material stream). Alternatively, the third material stream may comprise only the sixth material stream. At least a portion (e.g., all or the portion that is not recycled) of the fourth material stream may be provided or coupled (e.g., as is, or further combined with one or more other materials) to one or more uses. Examples of such uses may include, but are not limited to, for example, providing the fourth material stream to a pipeline, reinjecting the fourth material stream into a pipeline, providing the fourth material stream to a refinery (e.g., the fourth material stream may be used in refining operations, such as, for example, a hydrogen-rich fourth material stream may be used for hydrogenation), using the fourth material stream in a combined or simple cycle gas turbine or steam turbine (e.g., as a combustible fuel), utilizing the fourth material stream in production of ammonia (e.g., a hydrogen-rich fourth material stream may be used in a Haber-Bosch process to produce ammonia), utilizing the fourth material stream in production of methanol (e.g., using the fourth material stream in catalytic conversion to methanol), and/or liquefying the fourth material stream (e.g., to produce liquid hydrogen from a hydrogen-rich fourth material stream through liquefaction). The fourth material stream may have a suitable composition (e.g., purity) for such uses. Processing in accordance with the present disclosure may comprise, for example, generating the fifth material stream (e.g., comprising carbon particles, such as, for example, carbon black) and the fourth material stream (e.g., a material stream comprising hydrogen) from one or more material streams, and providing or coupling the fourth material stream (e.g., the material stream comprising hydrogen) to one or more of the aforementioned uses. The one or more material streams may include the first material stream, the second material stream and/or the eighth material stream (e.g., a material stream comprising a feedstock). At least one material stream (e.g., the third material stream) among the one or more material streams (e.g., a thermal transfer gas) may be heated (e.g., with electrical energy). While materials and transfer of materials between conversion steps or stages may be described herein primarily in terms of or in the context of material streams, any description of a material stream herein may equally apply to the material itself at least in some configurations, and vice versa. A material stream may refer to the material itself. A material stream may refer to a transfer of the material (e.g., continuous flow or batch transfer). The terms “material” and “material stream” may be used interchangeably. A given material stream may be heated before, during and/or after a given conversion step or stage. Alternatively, or in addition, the given material stream may be cooled before, during and/or after the given conversion step or stage. For example, the material stream may be heated before the given conversion step or stage, and/or heated or cooled during the given conversion step or stage (e.g., as part of a reaction mixture). After the given conversion step or stage, a material stream may be cooled, heated or neither (e.g., the material stream may already be at a suitable temperature when it exits the given conversion step or stage. The present disclosure provides heat integration of one or more of the conversion steps or stages with each other and/or with one or more material streams (e.g., flows) to/from one or more conversion steps or stages. Heat integration of one or more of the conversion steps or stages with each other may include heat integration of one or more material flows to/from such conversion steps or stages. For example, waste heat sharing between the first conversion step or stage and the second conversion step or stage may be implemented (e.g., waste heat may be shared between the steps of generating the carbon particles, and converting at least a portion of the first material stream to the second material stream). A given conversion step or stage (e.g., the second conversion step or stage) may provide waste heat to at least one (e.g., 1, 2, 3, 4, 5, 6, 7, 8, 9, 10 or more) other conversion steps or stages. A given conversion step or stage may provide waste heat to at least one other conversion step or stage during at least a portion (e.g., an exothermic portion) of the given conversion step or stage, and may receive waste heat from at least one other conversion step or stage during at least another portion (e.g., an endothermic portion) of the given conversion step or stage. A given conversion step or stage may provide or receive waste heat from itself (e.g., waste heat may be shared between a material stream entering or exiting the conversion step or stage, and at least a portion of the conversion step or stage itself (e.g., at least a portion of reaction)). For example, an exothermic reaction may preheat an input material stream. A given material stream may be separately heated before, during and/or after a given conversion step or stage. Alternatively, or in addition, the given material stream may not be separately heated before, during and/or after the given conversion step or stage (e.g., waste heat from another step or stage may be used for the heating instead of a separate heat source). At least a portion or all of the heating before, during and/or after the given conversion step or stage may be performed using waste heat from one or more other conversion steps or stages. For example, the first material stream may be at least in part (e.g., fully) heated (e.g., before the first conversion step or stage) by waste heat from the second conversion step or stage (e.g., the first material stream provided to the first conversion step or stage may not be heated from a separate heat source), at least a portion of the first conversion step or stage may be at least in part heated by waste heat from the second conversion step or stage (e.g., the conversion of the first material stream to the second material stream may not be heated from a separate heat source), and/or one or more of the material stream(s) provided to the second conversion step or stage (e.g., the first material stream, the second material stream, the at least one eighth material stream, and/or the third material stream) may be at least in part (e.g., fully) heated (e.g., before the second conversion step or stage) by waste heat from the second conversion step or stage (e.g., one or more of the material stream(s) provided to the second conversion step or stage may not be heated from a separate heat source). Waste heat may be provided from the second conversion step or stage to the first conversion step or stage, and/or vice versa. Waste heat from generating the fourth and fifth material streams (e.g., from generating the carbon particles) in the second conversion step or stage may be used in converting at least a portion of the first material stream to the second material stream (e.g., feedstock conversion). For example, at least about 0.1%, 1%, 2%, 3%, 4%, 5%, 10%, 15%, 20%, 25%, 30%, 35%, 40%, 45%, 50%, 55%, 60%, 65%, 70%, 75%, 80%, 85%, 90%, 95%, 99% or 100% of heat to drive the conversion of the first material stream to the second material stream may come from waste heat from converting at least one of the first material stream and the second material stream in the presence of the third material stream, or from converting the third material stream and at least one of the first material stream and the second material stream, to the fourth and fifth material streams (e.g., waste heat from generating the carbon particles may be used in converting at least a portion of the first material stream to the second material stream; waste heat from generating the carbon particles may be used to provide at least a portion (e.g., some or all) of the required thermal energy for converting at least a portion of the first material stream to the second material stream; etc.). Alternatively, or in addition, waste heat may be shared between the first conversion step or stage, and one or more other conversion steps or stages (e.g., such as a heat exchanger, pelletizer, dryer and/or other process steps described herein, for example, in relation to FIGS. 1 and 2). The first conversion step or stage may be endothermic, exothermic or a combination thereof (e.g., in a given sequence). Heating and/or cooling rates may be varied to achieve suitable heating and/or cooling of materials and/or conversion steps or stages (or portions thereof). Heat may be added to one or more of the first material and the ninth material before the first conversion step or stage, to at least a portion of the first conversion step or stage, and/or to one or more of the first material stream, the second material stream, the at least one seventh material stream, the at least one eighth material stream and the third material stream after the first conversion step or stage. The heat may be added, for example, by Joule heating (e.g., resistive heating), and/or by heat exchange with one or more fluids (e.g., via combustion of a fuel and/or waste heat from elsewhere in the system, as described in greater detail elsewhere herein). For example, the heat may be added by combustion of a fuel (e.g., combustion of leftover hydrogen), Joule heating, integration of heat from other conversion steps or stages, or any combination thereof (e.g., the heat may be added by combustion of a fuel (e.g., combustion of leftover hydrogen) and/or Joule heating, and any (or both) of these may also integrate heat from other conversion steps or stages). Various combinations of such heating methods may be implemented to achieve a suitable temperature (e.g., heat exchange with combustion and/or waste heat fluids may be implemented to achieve a first temperature, and Joule heating may be implemented to achieve a second temperature greater than the first temperature, etc.). The heat may be added by heat exchange with one or more fluids (e.g., with combustion flue gases; with one or more (e.g., waste heat) material streams, such as, for example, with a material stream exiting the second conversion step or stage, or with a material stream entering or exiting a heat exchanger, such as, for example, heat exchanger 103 or 213; etc.). The heat exchange may be achieved, for example, by contacting a flow channel (e.g., tube(s)) containing a given material (e.g., the first material stream, material stream being converted in the first conversion step or stage, etc.) with the one or more fluids (e.g., on the outside of the tube(s)), and transferring heat from the one or more fluids to the given material through a wall of the channel. The one or more channels (e.g., tubes) and the one or more fluids may be arranged in a heat exchanger. The Joule heating (e.g., resistive heating) may be achieved, for example, by placing a resistive heater adjacent to a vessel/chamber or a flow channel (e.g., tube(s)) containing a given material (e.g., by wrapping the vessel/chamber or the flow channel (e.g., tube(s)) containing the given material (e.g., first material stream, material stream being converted in the first conversion step or stage, etc.) with a resistive heating coil, tape or jacket). The first material stream (e.g., natural gas) may be heated (e.g., before the first conversion step or stage) by allowing one or more channels (e.g., tubes) containing the first material stream to exchange heat (e.g., in a heat exchanger) with a material stream from, for example, the second conversion step or stage (e.g., a material stream comprising carbon particles (e.g., carbon black) and hydrogen). The first material stream (e.g., natural gas) may be heated (e.g., before the first conversion step or stage) by allowing one or more channels (e.g., tubes) containing the first material stream to exchange heat (e.g., in a heat exchanger) with combustion flue gas(es) (e.g., flue gases on the outside of the tubes). The first material stream (e.g., natural gas) may be heated (e.g., before the first conversion step or stage) by wrapping one or more channels (e.g., tubes) containing the first material stream with a resistive heating coil, tape or jacket. The preheated first material stream may be provided to the first conversion step or stage. Any description of heat addition to a first material stream herein may equally apply to heat addition to other material streams at least in some configurations. The first conversion step or stage may be heated, for example, by wrapping at least a portion of a vessel/chamber or tube(s) in which the conversion takes place and where heat is to be added with a Joule heater (e.g., resistive heater). The first conversion step or stage may be heated, for example, by surrounding at least a portion of a vessel/chamber or tube(s) in which the conversion takes place and where heat is to be added with a flow channel vessel/chamber (e.g., a vessel/chamber within a larger vessel/chamber, or tube in tube) containing one or more hot fluids (e.g., combustion flue gases; one or more (e.g., waste heat) material streams, such as, for example, a material stream exiting the second conversion step or stage, or a material stream entering or exiting a heat exchanger, such as, for example, heat exchanger 103 or 213; etc.). Alternatively, or in addition, heat may be removed from one or more of the first material and the ninth material before the first conversion step or stage, from at least a portion of the first conversion step or stage, and/or from one or more of the second material stream, the least one seventh material stream and the at least one eighth material stream after the first conversion step or stage. The heat may be removed, for example, by heat exchange in a manner analogous to that of heat addition but now transferring heat from the given material to one or more fluids colder than the given material. The one or more fluids suitable for cooling may be provided, for example, from one or more processing steps described elsewhere herein (e.g., in relation to FIGS. 1 and 2).

The carbon particles of the present disclosure may be generated through one or more conversion steps or stages. These steps or stages may include feedstock conversion steps or stages described elsewhere herein. The carbon particles may be generated through, for example, greater than or equal to 1, 2, 3, 4, 5, 6, 7, 8, 9, 10, 12, 14, 16, 18, 20, 22, 24, 26, 28, 30, 35, 40, 45, 50, 55, 60, 65, 70, 75, 80, 85, 90, 95 or 100 conversion steps or stages. Alternatively, or in addition, carbon particles may be generated through, for example, less than or equal to 100, 95, 90, 85, 80, 75, 70, 65, 60, 55, 50, 45, 40, 35, 30, 28, 26, 24, 22, 20, 18, 16, 14, 12, 10, 9, 8, 7, 6, 5, 4, 3 or 2 conversion steps or stages. For example, the carbon particles may be generated through single-stage or multi-stage conversion.

### EXAMPLES

### Example 1

While useful with any unit operation-containing carbon particle (e.g., carbon black) generating system, this example describes the use of feedstock with reference to a system in accordance with FIG. 2. By replacing methane gas with ethane gas, the heavier feedstock may enrich the feedstock used and increase the production rate of a reactor, heat exchanger and/or filter limited grade so that it more fully utilizes the capacity of downstream equipment, potentially enabling higher sales and profitability. Other unit operations described herein in relation to FIG. 2 may be subjected to the balancing and enhanced utilization as described herein as well.

As further demonstrated in the TABLE 1 below, for the same power (kilowatts=kW), a carbon black production unit may make the same amount of N326 as N330 grade carbon black (CB). However, N330 has a higher OAN (oil absorption number) and so may need more water per kilogram produced to pelletize, which may dictate the need for a larger dryer. If a unit had such a larger dryer, then using ethane to make N326 may increase the production rate to 168 kilograms(kg)/hour(hr) and still leave some dryer capacity unutilized. Similarly, for the filter, using ethane may reduce the required filter size. The replacement of methane with ethane may reduce the required filter area (e.g., should some of the filter capacity get damaged, or a difficult-to-filter grade be manufactured on the same unit).

TABLE 1*

| | | Feedstock | | | |
|---|---|---|---|---|---|
| | | Methane | Methane | Ethane | Ethane |
| Grade | | N326 | N330 | N326 | N330 |
| OAN | | 72 | 102 | 72 | 102 |
| Torch Power | kW | 750 | 750 | 750 | 750 |
| Reactor Temp | ° C. | 1400 | 1400 | 1400 | 1400 |
| CB Production | kg/hr | 128 | 128 | 168 | 168 |
| Filtration Rate | Nm³/hr | 1353 | 1353 | 1423 | 1423 |
| Sp. Filter Rate | Nm³/kg | 11 | 11 | 8 | 8 |
| Dryer Evap. | kgH₂O/hr | 101 | 143 | 133 | 189 |

*C = centigrade; Temp = temperature; Sp. = specific; Evap. = evaporation; Nm³ = normal meter, i.e., cubic meter of gas at normal conditions, i.e., 0° C., and 1 atmosphere of pressure.

### Example 2

A unit fully utilized making N330 may also need to make N234. This grade may require more energy per kilo of carbon black, but may not have a sufficiently large power supply. By adding ethane, the unit may make more N234, and so satisfy customer demands that the equipment may not when using methane.

TABLE 2

| | | Feedstock | | | |
|---|---|---|---|---|---|
| | | Methane | Methane | Ethane | Ethane |
| Grade | | N234 | N330 | N234 | N330 |
| OAN | | 125 | 102 | 125 | 102 |
| Torch Power | kW | 750 | 750 | 750 | 750 |
| Reactor Temp | ° C. | 1925 | 1400 | 1925 | 1400 |
| CB Production | kg/hr | 85 | 128 | 110 | 168 |
| Filtration Rate | Nm³/hr | 1513 | 1353 | 1552 | 1423 |
| Sp. Filter Rate | Nm³/kg | 19 | 11 | 14.5 | 8 |
| Dryer Evap. | kgH₂O/hr | 117 | 143 | 151 | 189 |

Thus, the scope of the invention shall include all modifications and variations that may fall within the scope of the attached claims. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1.-16. (canceled)

17. A method for generating carbon particles, comprising:
(a) providing a first material stream;
(b) heating a second material stream;
(c) generating, in a reactor, the carbon particles and a third material stream using the second material stream and the first material stream; and
(d) providing the third material stream to a pipeline.

18. The method of claim 17, wherein the third material stream comprises hydrogen.

19. The method of claim 18, wherein the third material stream is hydrogen-rich.

20. The method of claim 17, wherein the second material stream comprises greater than about 60% hydrogen.

21. The method of claim 17, wherein the carbon particles comprise carbon black.

22. The method of claim 17, wherein the first material stream comprises one or more hydrocarbons.

23. The method of claim 23, wherein the first material stream comprises methane.

24. The method of claim 24, wherein the first material stream comprises natural gas.

25. The method of claim 17, further comprising mixing the first material stream and the second material stream in the reactor.

26. The method of claim 17, further comprising, in (c), generating the carbon particles in an environment substantially free of atmospheric oxygen.

27. The method of claim 17, further comprising, in (b), electrically heating the second material stream.

28. The method of claim 27, further comprising electrically heating the second material stream using a plasma generator.

29. The method of claim 17, further comprising, prior to (d), separating the carbon particles from the third material stream.

30. The method of claim 17, further comprising recycling the third material stream to the reactor.

31. A method for generating carbon particles, comprising:
(a) providing a first material stream;
(b) heating a second material stream;
(c) generating, in a reactor, the carbon particles and a third material stream using the second material stream and the first material stream; and
(d) providing the third material stream to a refinery, utilizing the third material stream in production of ammonia, or utilizing the third material stream in production of methanol.

32. The method of claim 31, further comprising, in (d), utilizing the third material stream in a Haber-Bosch process to produce the ammonia.

33. The method of claim 31, further comprising, in (d), utilizing the third material stream in a catalytic conversion to produce the methanol.

34. A method for generating carbon particles, comprising:
(a) providing a first material stream;
(b) heating a second material stream;
(c) generating, in a reactor, the carbon particles and a third material stream using the second material stream and the first material stream; and
(d) liquefying the third material stream.

35. The method of claim 34, wherein, in (d), the liquefying comprises producing liquid hydrogen from the third material stream.

36. The method of claim 34, wherein, in (d), the third material stream has a suitable purity for the liquefying.
